(19) United States
(12) Patent Application Publication
(10) Pub. No.: US 2009/0268438 A1
(43) Pub. Date: Oct. 29, 2009

(54) SOLAR ILLUMINATION-AND-SURVEILLANCE DEVICE FOR A HOME GARDEN

(76) Inventor: Yao-Hung HUANG, Yongkang CIty (TW)

Correspondence Address: SINORICA, LLC, 2275 Research Blvd., Suite 500, ROCKVILLE, MD, 20850, US

(21) Appl. No.: 12/107,914

(22) Filed: Apr. 23, 2008

(51) Int. Cl. F21L 4/00

(52) U.S. Cl. 362/183

(57) ABSTRACT

A solar illumination-and-surveillance device for a home garden includes a support post, a lamp positioned at the upper end of the support post for receiving a light source member, a surveillance camera installed at a preset location of the lamp and having a lens for receiving and picking up images, which are processed and then transmitted to a receiving device by an emission device, and a solar power supply module assembled at the topside of the lamp and disposed with a upper cover having its surface installed with a solar panel. The upper cover is provided inside with a battery and a driving circuit electrically connected with the solar panel, the lamp and the surveillance camera. Solar energy absorbed in the daytime is changed into electric energy through photoelectric conversion and the electric energy is stored in the battery to be used at night.

### BACKGROUND OF THE INVENTION

1. Field of the Invention

This invention relates to a solar illumination-and-surveillance device for a home garden, particularly to one making use of solar energy and able to convert the solar energy into electric source to be used by the lamp and the camera installed in the home garden for carrying out illumination and surveillance at the same time

2. Description of the Prior Art

Nowadays people pay much attention to promotion of living quality and become more and more particular about decoration of their living surroundings. A single house with a comparatively large area always has a courtyard in which illumination equipment is installed for lighting as well as for elevating safety of the living surroundings at night and also for adding elegant and esthetic decoration to the courtyard. However, although the courtyard is installed with the illumination equipment for lighting at night, it is still impossible to stop thieves or evildoers from intruding.

Further, the illumination equipment in the courtyard is generally supplied with electricity offered by a power company; therefore, electric wires must be employed for power connection, inconvenient in assembly and wasting electric power. If a self-supply electric source like battery is used, it can avoid trouble of wiring work, but cannot tally with economic gain.

As commonly known, solar energy has some advantages, such as environmental protection, and safety and convenience in use; therefore, solar energy is extensively used to supply electricity for street lamps, signal lamps and the like. If solar energy can be applied for illumination equipment in a courtyard, it can surely save electric power, and attain effects of environmental protection and convenience in use.

### SUMMARY OF THE INVENTION

The objective of this invention is to offer a solar illumination-and-surveillance device for a home garden, able to convert solar energy absorbed at daytime into electric energy to be stored in a battery and used for lighting at night, and having effects of environmental protection and saving electricity.

The solar illumination-and-surveillance device for a home garden in the present invention includes a support post, a lamp, a surveillance camera, a receiving device and a solar power supply module.

The support post is provided to stand still in a home garden, on a traffic island, in a park or other places where illumination and surveillance are required. The lamp is provided with a lamp holder positioned at the upper end of the support post for receiving a light member that gives out light. The light source member has its outside covered with a lamp casing combined together with the lamp holder. The surveillance camera installed at a preset location of the lamp is disposed with a lens for receiving and picking up images. After processed, the image data are transmitted to the receiving device for displaying by an emission device. The solar power supply module is installed at a preset location of the topside of the lamp and provided with an upper cover having its slanting surface set thereon with a solar panel, and the upper cover is assembled inside with a battery and a driving circuit that are electrically connected with the solar panel and the lamp as well as the surveillance camera.

Solar energy absorbed by the solar panel of the solar power supply module is changed into electric energy through photoelectric conversion to be stored in the battery. Then, the electric energy in the battery is led by the driving circuit and supplied to the lamp and the surveillance camera to actuate them to function.

By so designing, solar energy absorbed by the solar panel at daytime is converted into electric energy to be stored in the battery. Thus, the lamp and the surveillance camera can be supplied with the electric energy for use at night, having effects of environmental protection and saving electric power.

### BRIEF DESCRIPTION OF DRAWINGS

This invention will be better understood by referring to the accompany drawings, wherein:

FIG. 1 is a perspective view of a solar illumination-and-surveillance device for a home garden in the present invention;

FIG. 2 is a side view of the solar illumination-and-surveillance device for a home garden in the present invention;

FIG. 3 is an operation flow chart of solar energy in the device in the present invention; and

FIG. 4 is a perspective view of the solar illumination-and-surveillance device for a home garden in a using condition in the present invention.

### DETAILED DESCRIPTION OF THE PREFERRED EMBODIMENT

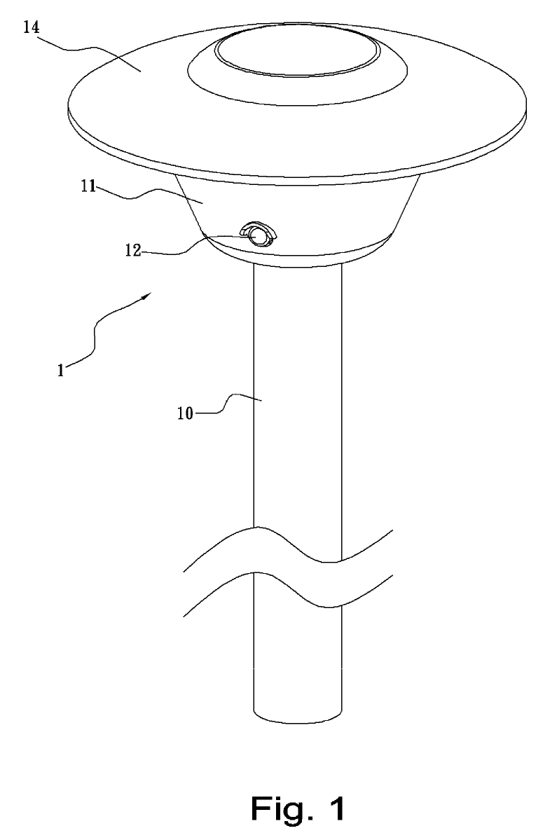

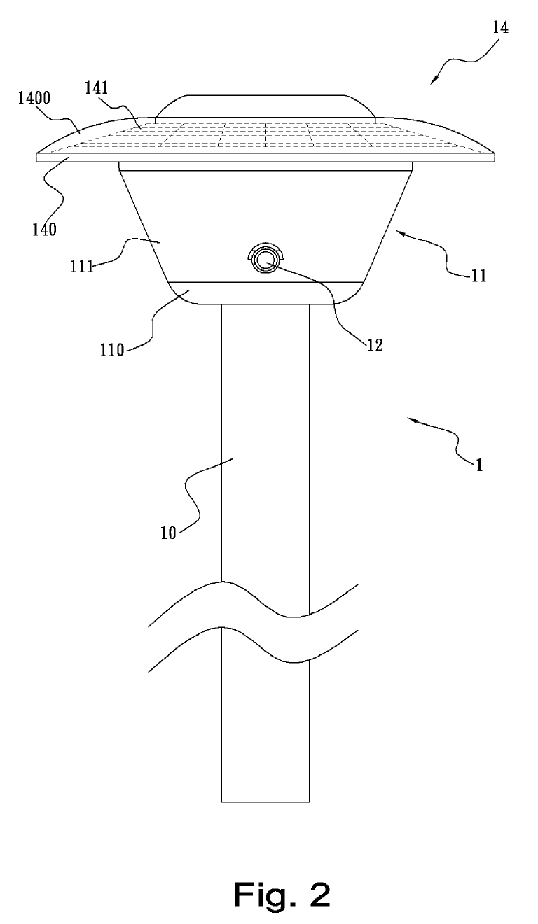

A preferred embodiment of a solar illumination-and-surveillance device 1 for a home garden in the present invention, as shown in FIGS. 1 and 2, includes a support post 10, a lamp 11, a surveillance camera 12, a receiving device 13 and a solar power supply module 14 as main components combined together.

The support post 10 for supporting the solar illumination-and-surveillance device 1 is provided to stand still in a home garden, on a traffic island, in a park or in other places where illumination and surveillance are needed.

The lamp 11 consists of a lamp holder 110, a light source member (not shown) and a lamp casing 111. The lamp holder 110 is positioned at the upper end of the support post 10 for supporting and receiving the light source member that emits light for lighting the home garden. The lamp casing 111 is covered around the light source member and combined together with the lamp holder 110.

The surveillance camera 12 is assembled at a preset location of the lamp 11 and provided with a lens for receiving and picking up images reflected therein, and simultaneously the image data are processed by the internal circuit of the surveillance camera 12. Afterwards, the image data are transmitted to the receiving device 13 through wireless transmission by an emission device. The receiving device 13 can be a display device or a mobile phone that is disposed with a display screen.

The solar power supply module 14 assembled at the topside of the lamp 11 is provided with a cap-shaped upper cover 140 formed with a slanting surface assembled thereon with a solar panel 141 having its outside mounted with a transparent cover plate 1400 for hiding and protecting the solar panel 141. A Ni-MH battery 143 and a driving circuit 142 are installed in the interior of the upper cover 140 and electrically connected with the solar panel 141 and the lamp 11 as well as the surveillance camera 12. Thus, after solar luminous energy is absorbed by the solar panel 141, the solar luminous energy will be altered into electric energy through photoelectric conversion to be stored in the battery. Then, the electric energy in the battery is led by the driving circuit and supplied to the lamp 11 and the surveillance camera 12 for actuating them to function.

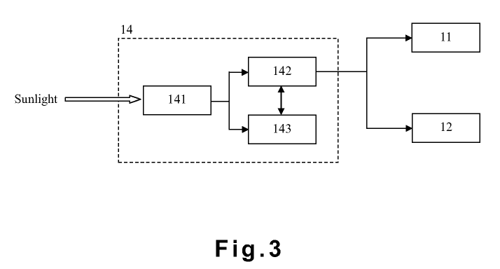

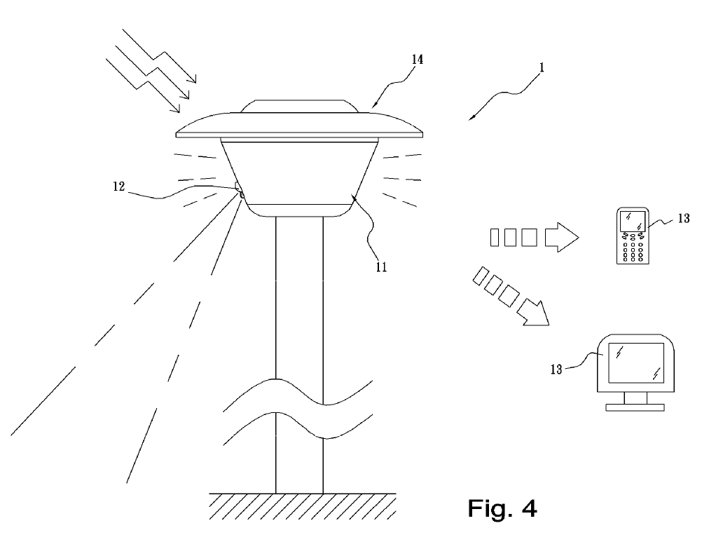

Referring to FIGS. 3 and 4, the solar panel 141 of the solar power supply module 14 is glued on the surface of the upper cover 140 and arranged slantwise to match with the shining angles of the sunlight for effectively absorbing overall sunlight and elevating sunlight collecting efficiency. Thus, in the daytime, the solar panel 141 absorbs enough solar energy to be converted into electric energy and then the electric energy is stored in the Ni-MH battery 143. Subsequently, the electric energy in the battery 143 is led by the driving circuit 142 and supplied to the lamp 11 and the surveillance 12 with enough electric power for carrying out functional operation; that is, the lamp 11 can give out light and the surveillance 12 can receive and pick up images around the surroundings through the lens. Simultaneously, the image data are transmitted to the receiving device 13 in a way of wireless transmission by the emission device. The receiving device 13 can be a display or a personal mobile phone positioned in a room. By so designing, through the screen of the receiving device 13, a user can know the situation around the solar illumination-and-surveillance device 1 in the home garden and immediately take action to cope with the situation for avoiding causing accidents. The wireless transmission mentioned above is preferably a mode of blue-tooth wireless transmission.

In addition, a motion sensor can be provided at a preset location for saving electric source of the battery. Under the control of the driving circuit, the lamp 11 is normally off, but when any abject moves or approaches within an effective range of the motion sensor, the motion sensor will detect its movement and instantly produce an electric signal and transmit it to the driving circuit for actuating the lamp 11 to give out light. After the lamp 11 continuously carries out illuminating for a specified time and if the motion sensor on longer detects any object moving around, the driving circuit will turn off the lamp 11 again. Evidently, the motion sensor of this invention can effectively economize power energy and prolong service life of the battery.

While the preferred embodiment of the invention has been described above, it will be recognized and understood that various modifications may be made therein and the appended claims are intended to cover all such modifications that may fall within the spirit and scope of the invention.

I claim:

1. A solar illumination-and-surveillance device for a home garden comprising:
a support post;
a lamp provided at an upper end of said support post, said lamp disposed with a light source member for emitting light, said light member having its outer side covered with a lamp casing;
a surveillance camera positioned at a preset location of said lamp, said surveillance camera provided with a lens for receiving and picking up images, and an emission device for processing said image data and then transmitting them to a receiving device;
a solar power supply module assembled at a preset location of the topside of said lamp, said solar power supply module mounted with an upper cover having its surface assembled thereon with a solar panel, a battery and a driving circuit installed in the interior of said upper cover and electrically connected with said solar panel, said battery and said driving circuit also electrically connected with said lamp and said surveillance camera; and
Said solar panel of said solar power supply module absorbing solar energy, said solar energy changed into electric energy through photoelectric conversion to be stored in said battery, said electric energy in said battery led by said driving circuit and supplied to said lamp and said surveillance camera for carrying out functional operation.

2. The solar illumination-and-surveillance device for a home garden as claimed in claim 1, wherein a transparent cover plate is assembled on an outside of said solar panel for hiding and protecting said solar panel.

3. The solar illumination-and-surveillance device for a home garden as claimed in claim 1, wherein said surveillance camera transmits said image data to said receiving device through wireless transmission.

4. The solar illumination-and-surveillance device for a home garden as claimed in claim 1, wherein said surveillance camera transmits said image data to said receiving device through blue-tooth wireless transmission.

5. The solar illumination-and-surveillance device for a home garden as claimed in claim 1, wherein said receiving device is a display formed with a screen.

6. The solar illumination-and-surveillance device for a home garden as claimed in claim 1, wherein said receiving device is a mobile phone.

7. The solar illumination-and-surveillance device for a home garden as claimed in claim 1, wherein said solar illumination-and-surveillance device is provided with a emotion sensor at a preset location.
